(19) United States
(12) Patent Application Publication
(10) Pub. No.: US 2026/0265105 A1
(43) Pub. Date: Sep. 10, 2026

(54) SYSTEM FOR RESOURCE RECOVERY AND ZERO LIQUID DISCHARGE TREATMENT OF WASTEWATER GENERATED DURING A PRECURSOR MANUFACTURING PROCESS FOR A CATHODE ACTIVE MATERIAL OF SECONDARY BATTERY

(71) Applicant: BKT CO., LTD., Daejeon (KR)

(72) Inventors: Jangkyu KIM, Seongnam-si Gyeonggi-do (KR); Sang Ug KIM, Sejong-si (KR); Tae Shin PARK, Yangju-si Gyeonggi-do (KR); Keun Chan YU, Sejong-si (KR); Su Bin KIM, Daejeon (KR); Bo Hyun KIM, Sejong-si (KR)

(73) Assignee: BKT CO., LTD., Daejeon (KR)

(21) Appl. No.: 19/660,533

(22) Filed: Apr. 28, 2026

Related U.S. Application Data
(63) Continuation of application No. PCT/KR2024/007848, filed on Jun. 10, 2024.

(30) Foreign Application Priority Data
Nov. 8, 2023 (KR) 10-2023-0153201

(51) Int. Cl. C02F 9/00; C02F 1/02; C02F 1/26; C02F 1/28; C02F 1/42; C02F 1/469; C02F 1/74; C02F 101/10; C02F 101/16; C02F 101/20; C02F 103/34; H01M 4/02; H01M 4/04; H01M 10/0525

(52) U.S. Cl. CPC C02F 9/00; C02F 1/02; C02F 1/265; C02F 1/283; C02F 1/42; C02F 2001/425; C02F 1/4693; C02F 1/74; C02F 2101/101; C02F 2101/16; C02F 2101/206; C02F 2103/34; C02F 2201/46115; C02F 2201/46165; H01M 2004/028; H01M 4/0497; H01M 10/0525

(57) ABSTRACT

Disclosed is a system for treating wastewater containing heavy metals and high-concentration ammonia generated during a manufacturing process for a cathode active material precursor of a secondary battery. According to one aspect of the present disclosure, there is provided a system for zero liquid discharge (ZLD) treatment of wastewater generated during a manufacturing process for a cathode active material precursor of a secondary battery, the system including: an ammonia stripping unit configured to remove an ammonia component from wastewater generated during the precursor manufacturing process; an ion exchange (IX) unit configured to remove metal ions; a chemical recovery unit configured to recover an acid solution and an alkaline solution; and a water reclamation unit configured to produce, from the wastewater from which the acid solution and the alkaline solution have been recovered, reclaimed water for use in the system.

### CROSS-REFERENCE TO RELATED APPLICATIONS

This application is a continuation of International Application No. PCT/KR2024/007848, filed on Jun. 10, 2024, which claims priority to Korean Patent Application No. 10-2023-0153201, filed on Nov. 8, 2023, the entire contents of which are herein incorporated by reference.

### TECHNICAL FIELD

The present disclosure relates to a wastewater treatment system for achieving resource recovery and zero liquid discharge (ZLD) by treating wastewater generated from a manufacturing process of a precursor for a cathode active material of a lithium-ion secondary battery.

### BACKGROUND ART

The content described in this section simply provides background information for this embodiment only and does not constitute the related art.

Lithium-ion secondary batteries have been employed across a wide range of applications, from portable batteries for IT devices such as smartphones and laptops to major energy sources for electric vehicles (EVs), owing to their high output and high energy density characteristics. In particular, the demand for lithium-ion batteries has been rapidly increasing, driven by the surge in demand for eco-friendly technologies such as electric vehicles (EVs) and energy storage systems (ESSs).

A cathode active material is one of the key materials constituting a lithium-ion secondary battery and accounts for a significant portion of the manufacturing cost of the lithium-ion secondary battery. As an active material exhibiting the characteristics of a positive electrode in a battery, the cathode active material is an important material that determines the capacity and voltage of the battery.

Such a cathode active material is manufactured by mixing a precursor with raw materials such as lithium, followed by a calcination process. The precursor serves as an intermediate raw material for the cathode active material and is manufactured by processing minerals such as nickel (Ni), cobalt (Co), manganese (Mn), and aluminum (Al).

Among the methods for manufacturing a precursor, the most commonly used method is a co-precipitation method, in which ions of two or more components are co-precipitated in an aqueous or non-aqueous solution to separate a target material. Such a co-precipitation method has the advantage that the operation of the reaction process and the control of reaction conditions are easy. However, it requires a long period of time for the precipitation reaction and generates large quantities of wastewater containing various chemicals and metal ions. In particular, the wastewater generated during the manufacturing process of a cathode active material precursor by the co-precipitation method is recognized as one of the industrial wastewaters that cause critically adverse effects on the environmental ecosystem.

Meanwhile, as methods for treating wastewater generated during the manufacturing process of a cathode active material precursor, methods such as precipitation, flocculation, adsorption, or removal of total nitrogen from wastewater using strong acids have been proposed. However, these wastewater treatment methods cause resource loss, as valuable resources contained in the wastewater are discarded. Therefore, there is an urgent need for an eco-friendly treatment approach capable of effectively treating heavy metals and ammonia components contained in the wastewater, while recovering and recycling materials that would otherwise be discharged without being valorized as resources.

### DISCLOSURE

### Technical Problem

One object of one embodiment of the present disclosure is to provide a wastewater treatment system capable of recovering resources, including acid solution and alkaline solution, from wastewater generated during the manufacturing process of a cathode active material precursor for a secondary battery, and reusing treated water discharged from the system as process water within the system, thereby achieving zero liquid discharge (ZLD) of the final waste liquid and fundamentally preventing environmental pollution caused thereby.

Another object of one embodiment of the present disclosure is to provide an eco-friendly water treatment system capable of reducing the production cost of the precursor by recovering chemicals from ammonia, heavy metals, and high-concentration saline components contained in wastewater generated during the manufacturing process of a cathode active material precursor for a secondary battery, and recycling the recovered chemicals as materials required for the precursor manufacturing process.

### Technical Solution

According to one aspect of the present disclosure, there is provided a zero liquid discharge (ZLD) treatment system for wastewater generated during the manufacturing process of a cathode active material precursor for a secondary battery, the system being configured to treat wastewater containing heavy metals and high-concentration ammonia generated during the precursor manufacturing process, wherein the system comprises an ammonia stripping unit configured to strip an ammonia component from the wastewater generated during the precursor manufacturing process, an ion exchange (IX) unit configured to receive the wastewater from which the ammonia component has been removed and to remove metal ions from the wastewater, a chemical recovery unit configured to recover acid solution and alkaline solution from the wastewater from which the ammonia component and the metal ions have been removed, and a water reclamation unit configured to filter the wastewater from which the acid solution and the alkaline solution have been recovered, thereby producing reclaimed water for reuse within the system.

According to one aspect of the present disclosure, the system further comprises a chemical concentration unit, wherein the chemical concentration unit is configured to concentrate the acid solution and the alkaline solution recovered by the chemical recovery unit and to supply the concentrated acid solution and alkaline solution back to the precursor manufacturing process.

According to one aspect of the present disclosure, the system further comprises a membrane filtration unit configured to receive the wastewater treated by the ion exchange (IX) unit, remove organic matter and particulate matter therefrom, and discharge the treated wastewater to the chemical recovery unit.

According to one aspect of the present disclosure, the chemical recovery unit comprises a bipolar membrane electrodialysis (BMED) apparatus configured to receive the wastewater and recover acid solution and alkaline solution therefrom.

According to one aspect of the present disclosure, the bipolar membrane electrodialysis apparatus comprises a plurality of unit stacks arranged in series to receive the wastewater and perform desalination treatment by recovering acid solution and alkaline solution in multiple stages.

According to one aspect of the present disclosure, the unit stack comprises a plurality of anion exchange membranes (AEM), cation exchange membranes (CEM), and bipolar membranes (BPM) positioned between an anode and a cathode, wherein the plurality of membranes are repeatedly arranged in the order of an anion exchange membrane, a cation exchange membrane, and a bipolar membrane, and spacers are disposed between adjacent membranes.

According to one aspect of the present disclosure, the bipolar membrane electrodialysis apparatus is configured to receive final treated water produced by the water reclamation unit as a recovery solution in order to recover acid solution and alkaline solution from the wastewater.

According to one aspect of the present disclosure, the bipolar membrane electrodialysis apparatus is configured to receive power supplied from a solar power generation system or a wind power generation system as a power source applied to the anode and the cathode.

According to one aspect of the present disclosure, the wastewater generated during the precursor manufacturing process and introduced into the ammonia stripping unit has a pH of 10 or greater.

According to one aspect of the present disclosure, the system further comprises an activated carbon adsorption unit, wherein the activated carbon adsorption unit is configured to receive concentrate in which residual pollutants not filtered by the water reclamation unit are concentrated and to remove organic matter from the concentrate, and wherein the concentrate from which the organic matter has been removed is recirculated to the chemical recovery unit to be merged into a flow path for supplying concentrate solution to the plurality of unit stacks.

According to one aspect of the present disclosure, the ion exchange (IX) unit comprises a cation exchange resin, and metal ions contained in the wastewater introduced into the ion exchange (IX) unit include one or more selected from the group consisting of nickel (Ni), cobalt (Co), manganese (Mn), and aluminum (Al).

According to one aspect of the present disclosure, the water reclamation unit is a reverse osmosis (RO) apparatus.

According to one aspect of the present disclosure, there is provided a method for zero liquid discharge (ZLD) treatment of wastewater generated during the manufacturing process of a cathode active material precursor for a secondary battery, the method being for treating wastewater containing heavy metals and high-concentration ammonia generated during the precursor manufacturing process, wherein the method comprises removing an ammonia component from the wastewater generated during the precursor manufacturing process, removing metal ions from the wastewater from which the ammonia component has been removed, removing organic matter and particulate matter from the wastewater from which the metal ions have been removed, recovering sulfuric acid (H₂SO₄) and sodium hydroxide (NaOH) from the wastewater from which the organic matter and the particulate matter have been removed, and producing reclaimed water by additionally removing residual salts from the desalinated wastewater from which the sulfuric acid and the sodium hydroxide have been recovered.

According to one aspect of the present disclosure, the produced reclaimed water is supplied to and reused in the step of recovering the sulfuric acid and the sodium hydroxide.

According to one aspect of the present disclosure, in the step of removing the ammonia component, the ammonia is removed by stripping the wastewater with air or steam.

According to one aspect of the present disclosure, in the step of recovering the sulfuric acid and the sodium hydroxide, the sulfuric acid and the sodium hydroxide are recovered from the wastewater by the bipolar membrane electrodialysis (BMED) apparatus.

### Advantageous Effects

As described above, according to one aspect of the present disclosure, by treating wastewater generated during the manufacturing process of a cathode active material precursor, chemicals contained in the wastewater can be recovered and reintroduced into the precursor manufacturing process, thereby enabling resource recycling, reducing environmental damage caused by waste discharged into the ecosystem, and lowering the production cost of the precursor.

In addition, by recovering chemicals from the wastewater generated during the precursor manufacturing process and producing reclaimed water from the discharged wastewater through a reverse osmosis (RO) process, the entire volume of the produced reclaimed water can be recirculated for reuse as process water within the system including the chemical recovery process, thereby achieving zero liquid discharge (ZLD) treatment of the system. Furthermore, salts contained in the concentrate from the reverse osmosis process are reintroduced into the chemical recovery process, thereby improving the chemical recovery rate and, at the same time, stably securing the power efficiency of the bipolar membrane electrodialysis (BMED) apparatus for chemical recovery.

### BRIEF DESCRIPTION OF DRAWINGS

FIG. 1 is a process flow diagram illustrating a system for resource recovery and zero liquid discharge (ZLD) treatment of wastewater generated during the manufacturing process of a cathode active material precursor for a secondary battery according to one embodiment of the present disclosure.

FIG. 2 is a diagram illustrating a configuration of a chemical recovery unit according to one embodiment of the present disclosure.

FIG. 3 is a diagram illustrating a unit stack structure of a bipolar membrane electrodialysis (BMED) apparatus of the chemical recovery unit according to one embodiment of the present disclosure.

FIG. 4 is a diagram illustrating a configuration of a chemical concentration unit according to one embodiment of the present disclosure.

FIG. 5 is a flowchart illustrating a method for zero liquid discharge (ZLD) treatment of wastewater generated during the manufacturing process of a cathode active material precursor for a secondary battery according to one embodiment of the present disclosure.

### MODE FOR INVENTION

Since the present disclosure may be modified in various forms and have various embodiments, specific embodiments will be illustrated in the drawings and described in detail. However, this is not intended to limit the present disclosure to the specific embodiments, and it should be understood that the present disclosure includes all changes, equivalents, and substitutes included in the spirit and technical scope of the present disclosure. While describing each drawing, similar reference numerals are used for similar components.

Terms such as first, second, A, and B may be used in describing various components, but the components should not be limited by the terms. The above terms are used only for the purpose of distinguishing one component from another. For example, a first component may be named a second component, and similarly, the second component may also be named a first component without departing from the scope of rights of the present disclosure. The term “and/or” includes a combination of a plurality of related described items or any one of the plurality of related described items.

When a component is mentioned to be “linked” or “connected” to another component, it may be directly linked to or connected to the other component, but it should be understood that another component may be present in the middle therebetween. Meanwhile, when it is mentioned that a component is “directly linked” or “directly connected” to another component, it should be understood that another component is not present in the middle therebetween.

The terms used in this application are only used to describe specific embodiments and are not intended to limit the present disclosure. Singular expressions include plural expressions unless the context clearly dictates otherwise. In this application, terms such as “include” or “have” should be understood as not precluding the existence or addition possibility of features, numbers, steps, operations, components, parts, or combinations thereof described in the specification.

Unless otherwise defined, all terms used herein, including technical or scientific terms, have the same meaning as generally understood by those skilled in the art to which the present disclosure pertains.

Terms such as those defined in commonly used dictionaries should be interpreted as having a meaning consistent with the meaning in the context of the related technology, and unless explicitly defined in this application, should not be interpreted in an ideal or excessively formal sense.

As used herein, the term “alkaline solution” refers to a solution having alkaline properties generated by the bipolar membrane electrodialysis (BMED) process within the chemical recovery unit 150, which corresponds to what is referred to as “base solution” in certain technical literature relating to BMED technology. In one embodiment, the alkaline solution comprises sodium hydroxide (NaOH).

As used herein, the term “recovery solution” refers to a solution introduced into specific flow paths of the unit stack of the bipolar membrane electrodialysis (BMED) apparatus to recover acid solution and alkaline solution from the concentrate solution, which corresponds to what is referred to as “electrode rinse solution (ERS)” in certain technical literature relating to BMED technology; the term “concentrate solution” refers to a high-salinity solution introduced into the unit stack of the bipolar membrane electrodialysis apparatus as a feed to be desalinated for the recovery of acid solution and alkaline solution, which corresponds to what is referred to as “brine” in certain technical literature relating to BMED technology; the term “desalinated solution” refers to the solution discharged from a unit stack of the bipolar membrane electrodialysis apparatus following removal of ionic components by electrodialysis, which corresponds to what is referred to as “diluted brine” in certain technical literature relating to BMED technology; and the term “recirculated concentrate” refers to the solution obtained by removing organic matter from the RO concentrate discharged from the water reclamation unit through the activated carbon adsorption unit, which is reintroduced into the concentrate solution supply flow path of the chemical recovery unit to replenish the salt concentration therein.

Additionally, each configuration, process, operation, method, or the like included in each embodiment of the present disclosure may be shared within the scope of not being technically contradictory to each other.

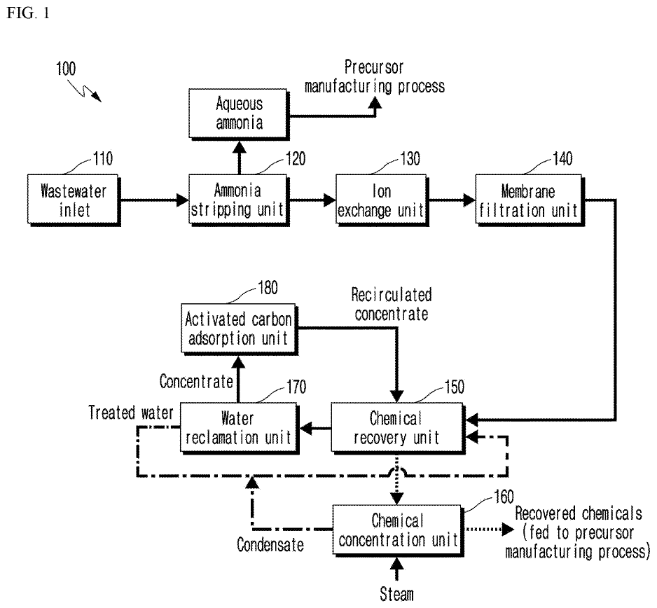

FIG. 1 is a diagram illustrating a system for resource recovery and zero liquid discharge (ZLD) treatment of wastewater generated during the manufacturing process of a cathode active material precursor for a secondary battery according to one embodiment of the present disclosure.

As shown in FIG. 1, a system 100 for resource recovery and zero liquid discharge (ZLD) treatment of wastewater generated during the manufacturing process of a cathode active material precursor for a secondary battery according to one embodiment of the present disclosure (hereinafter referred to as the “system 100”) comprises a wastewater inlet 110, an ammonia stripping unit 120, an ion exchange (IX) unit 130, a membrane filtration unit 140, a chemical recovery unit 150, a chemical concentration unit 160, a water reclamation unit 170, and an activated carbon adsorption unit 180.

The wastewater inlet 110 receives wastewater generated during the manufacturing process of a cathode active material precursor for a secondary battery and supplies the wastewater to the downstream ammonia stripping unit 120.

A lithium-ion secondary battery is composed of four major materials: a cathode active material, an anode active material, a separator, and an electrolyte, among which the cathode active material serves to provide lithium ions. A precursor, which is an intermediate raw material for the cathode active material, is generally manufactured by a co-precipitation method, in which metal salts of metals used in the cathode active material and an alkali are introduced into water as a solvent and precipitated as metal hydroxides to produce the precursor. In this method, the performance of the precursor may be determined depending on the concentrations of the metal salts, the alkali, and ammonia, as well as pH and reaction conditions.

Accordingly, the wastewater generated during the manufacturing process of a cathode active material precursor contains heavy metals, such as nickel (Ni), manganese (Mn), and cobalt (Co), at concentrations of several tens to several hundreds of ppm. In addition, since ammonia and sodium hydroxide (NaOH) are used in the precursor manufacturing process, the wastewater exhibits strong alkalinity and contains large amounts of inorganic salts and high-concentration ammonium ions. Among these, substances that can be recovered from the system 100 and reintroduced into the precursor manufacturing process for use include ammonia and inorganic salts.

As an example, the wastewater generated from the manufacturing process of a cathode active material precursor and introduced into the system 100 of the present disclosure contains a chemical oxygen demand (COD) of 50 to 100 mg/L, total dissolved solids (TDS) of 150,000 to 200,000 mg/L, ammonium ions (NH₄⁺) of 8,000 to 12,000 mg/L, sulfate (SO₄²⁻) of 100,000 to 120,000 mg/L, and other metal ions.

Accordingly, the wastewater introduced from the wastewater inlet 110 is supplied, as a first step, to the ammonia stripping unit 120, so that the ammonia component in the wastewater can be removed.

The ammonia stripping unit 120 receives the wastewater generated during the manufacturing process of a cathode active material precursor from the wastewater inlet 110, removes the ammonia component contained in the wastewater, and discharges the treated wastewater to the ion exchange (IX) unit 130.

The ammonia stripping unit 120 can remove ammonia in water by stripping the wastewater with air. The ammonia component exists in an equilibrium state in water, as represented by Chemical Formula 1 below.

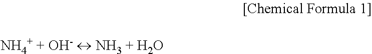

Ammonia exists as NH₄⁺ or NH₃ depending on the pH of the wastewater, and the equilibrium pH is 9.25. As the pH increases, ammonia increasingly exists in the form of NH₃. A method in which the pH is raised to 10 or greater and ammonia is then stripped with air is referred to as an ammonia stripping method.

As described above, since ammonia and sodium hydroxide (NaOH) are used in the manufacturing process of a cathode active material precursor, the pH of the generated wastewater is generally 10 or greater (at a level of pH 10 to 13). Therefore, the ammonia stripping unit 120 of the present disclosure can strip ammonia without artificially increasing the pH for ammonia stripping, and the pH of the wastewater from which ammonia has been removed through the ammonia stripping unit 120 can be adjusted to a level of 9 to 11.

In addition, the ammonia stripping unit 120 of the present disclosure may employ either an air stripping method using air or a steam stripping method using steam as a medium. When steam is used in the ammonia stripping process, there is an advantage in that the ammonia removal efficiency can be further improved as compared with a degassing method using air at room temperature.

As described above, wastewater generated during the manufacturing process of a cathode active material precursor is introduced into the ammonia stripping unit 120 and subjected to a degassing process. At this time, the concentration of ammonium ions (NH₄⁺) in the influent wastewater is at a level of 8,000 to 12,000 mg/L.

When ammonium ions flow into the downstream chemical recovery unit 150, the ammonium ions may be introduced into an alkali line and discharged as ammonia gas, which may reduce the power efficiency of the chemical recovery unit 150. Accordingly, the system 100 of the present disclosure introduces the ammonia stripping unit 120 as a primary pretreatment process for the main process, namely, the chemical recovery unit 150, so as to remove high-concentration ammonium ions. The wastewater having passed through the ammonia stripping unit 120 is treated so as to contain ammonium ions at a level of 20 to 100 mg/L and is then discharged to the ion exchange (IX) unit 130.

Meanwhile, ammonia separated by degassing in the ammonia stripping unit 120 is recovered in the form of aqueous ammonia, and the recovered aqueous ammonia is reused as a raw material for the precursor manufacturing process. In particular, in the case of the ammonia stripping unit 120 using steam as a medium, it is advantageous in that the recovered steam is condensed and recovered in the form of aqueous ammonia.

The ion exchange (IX) unit 130 receives the wastewater from which ammonium ions have been primarily removed by the ammonia stripping unit 120 and separates heavy metal components in the wastewater. Thereafter, the treated water from which the heavy metal components have been removed is discharged to the membrane filtration unit 140.

As described above, the wastewater generated during the manufacturing process of a cathode active material precursor contains at least one metal selected from among nickel (Ni), cobalt (Co), manganese (Mn), aluminum (Al), iron (Fe), and magnesium (Mg).

When such metal ions are introduced into the chemical recovery unit 150, metal crystals may be formed, and thus the efficiency of the ion exchange membranes 313 and 315 in the chemical recovery unit 150, which will be described below, may be reduced.

Accordingly, the system 100 of the present disclosure may further introduce the ion exchange (IX) unit 130 as a secondary pretreatment process for the chemical recovery unit 150 to remove metal ions in the wastewater. The ion exchange (IX) unit 130 includes an ion exchange resin in order to remove such metal ions, and may in particular be in the form of a packed column filled with a cation exchange resin.

The wastewater introduced into the ion exchange (IX) unit 130 contains metal ions such as nickel (Ni), cobalt (Co), manganese (Mn), aluminum (Al), iron (Fe), and magnesium (Mg) at a level of 50 to 100 mg/L, and the metal ions present in the wastewater can be completely removed through the ion exchange (IX) unit 130.

In addition, some of the metal ions removed in the ion exchange (IX) unit 130 may, depending on their concentrations, be recovered from the ion exchange resin and recirculated for use as raw materials for the precursor manufacturing process.

The membrane filtration unit 140 receives the wastewater from which metal ions have been secondarily removed in the ion exchange (IX) unit 130, removes organic matter and particulate matter from the wastewater, and discharges the treated wastewater to the chemical recovery unit 150.

As described above, the wastewater generated during the manufacturing process of a cathode active material precursor contains organic matter and particulate matter, which may cause a reduction in treatment efficiency in the chemical recovery unit 150. Accordingly, it is necessary to reduce the organic matter and particulate matter in the wastewater.

For example, the membrane filtration unit 140 may be an ultrafiltration (UF) membrane process. The treated water having completed the two-stage pretreatment of ammonia stripping and ion exchange passes through the membrane filtration unit 140 including a UF membrane, whereby particulate matter and organic matter are removed by membrane filtration, and is then discharged to the chemical recovery unit 150.

The chemical recovery unit 150 receives the wastewater from which organic matter and particulate matter have been removed in the membrane filtration unit 140, recovers acid solution (e.g., sulfuric acid, H₂SO₄) and alkaline solution (e.g., sodium hydroxide, NaOH), and discharges the same to the chemical concentration unit 160. In addition, desalinated water from which the acid solution and the alkaline solution have been removed is discharged to the water reclamation unit 170.

The wastewater introduced into the chemical recovery unit 150 generally contains 8 to 15 wt % of Na₂SO₄. In order to recover desalinated water, acid solution, and alkaline solution from such wastewater, a bipolar membrane electrodialysis (BMED) apparatus may be applied to the chemical recovery unit 150.

Since the bipolar membrane electrodialysis apparatus can separate or concentrate chemicals using only electrical energy through ion exchange membranes, it has advantages in that no by-products are generated during process operation and a large volume of wastewater can be treated with relatively low energy.

In order to apply the bipolar membrane electrodialysis apparatus as the chemical recovery unit 150, the system 100 arranges the ammonia stripping unit 120, the ion exchange (IX) unit 130, and the membrane filtration unit 140 at an upstream stage of the chemical recovery unit 150 so as to remove ammonia components, metal ions, and organic matter from the wastewater generated during the manufacturing process of a cathode active material precursor. The wastewater having undergone the above-described pretreatment processes is introduced into the chemical recovery unit 150 with a water quality level sufficient to achieve high treatment efficiency and stable recovery of chemicals in the bipolar membrane electrodialysis apparatus.

For example, after the wastewater generated during the manufacturing process of a cathode active material precursor passes through a series of pretreatment processes provided in the system 100 of the present disclosure—namely, the ammonia stripping unit 120, the ion exchange (IX) unit 130, and the membrane filtration unit 140—the influent water quality of the wastewater introduced into the chemical recovery unit 150 is as shown in Table 1. Organic matter, ammonia, and heavy metals contained in the wastewater generated during the manufacturing process of a cathode active material precursor are mostly removed at an upstream stage of the chemical recovery unit 150. As a result, a decrease in treatment efficiency and the generation of by-products in the chemical recovery unit 150 can be minimized.

TABLE 1

| Parameter | Concentration(mg/L) |
|---|---|
| COD | 30~70 |
| TDS | 150,000~200,000 |
| NH₄⁺ | 20~100 |
| Ni, Co, Mn | 0~1 |
| SS | <0.1 |
| Na⁺ | 40,000~60,000 |
| SO₄²⁻ | 90,000~120,000 |

The chemical recovery unit 150 requires a recovery solution for separating and recovering acid solution and alkaline solution from the introduced wastewater. In the system 100, the final effluent treated in the water reclamation unit 170 is recovered and used as the recovery solution.

In addition to using the wastewater introduced from the membrane filtration unit 140 as a concentrate solution, the chemical recovery unit 150 may further receive recirculated concentrate discharged from the activated carbon adsorption unit 180 and use the same as a salt solution for the bipolar membrane electrodialysis apparatus.

The chemical recovery unit 150 performs an electrodialysis process to recover acid solution and alkaline solution in the form of sulfuric acid (H₂SO₄) and sodium hydroxide (NaOH), respectively, from the wastewater. For example, when Na₂SO₄ at a level of 8 to 15 wt % is introduced into the chemical recovery unit 150, H₂SO₄ of 4 to 7 wt % and NaOH of 3 to 6 wt % can be recovered. In this case, the recovered chemicals are introduced into the chemical concentration unit 160 so that the concentrations of the acid solution and the alkaline solution may be adjusted to levels suitable for use in the precursor manufacturing process.

The treated water discharged from the chemical recovery unit 150 is discharged to the water reclamation unit 170 with a water quality having a TDS concentration of 13,000 to 15,000 mg/L as the acid solution and the alkaline solution are recovered.

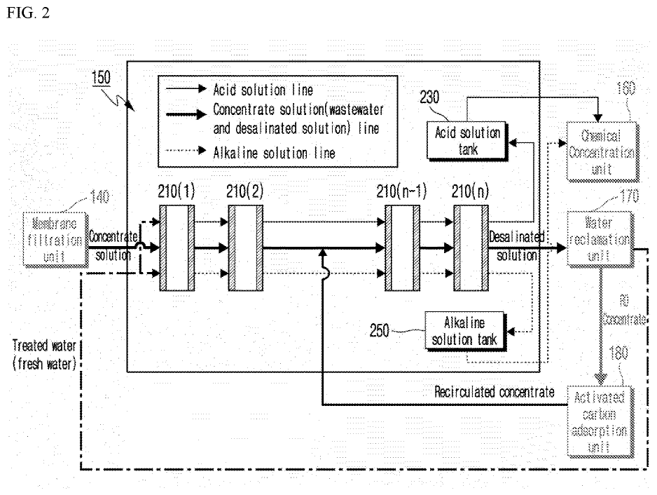

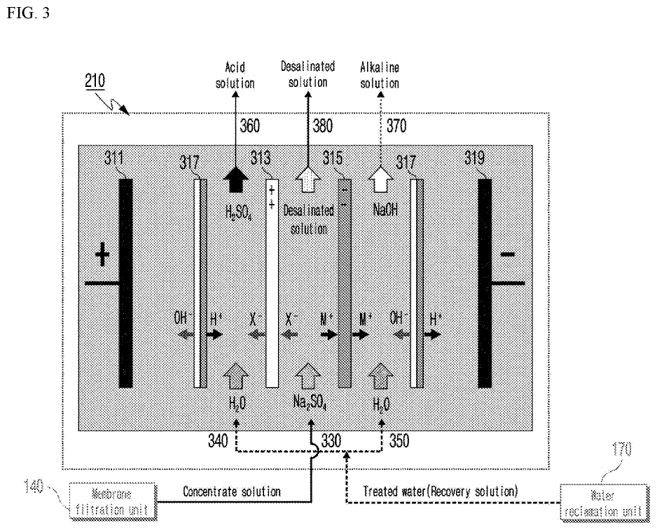

A detailed configuration of the chemical recovery unit 150 will be described below with reference to FIGS. 2 and 3.

The chemical concentration unit 160 receives the acid solution and the alkaline solution recovered by the chemical recovery unit 150 and subjects them to a concentration process in which the concentrations are adjusted to levels suitable for reuse in the precursor manufacturing process. The acid solution and the alkaline solution concentrated in this manner are supplied to the precursor manufacturing process.

The precursor manufacturing process generally uses acid solution (e.g., sulfuric acid, H₂SO₄) and alkaline solution (e.g., sodium hydroxide, NaOH) each having a concentration in the range of 20 to 50% for reaction efficiency. Accordingly, the acid solution and the alkaline solution recovered by the chemical recovery unit 150 need to be concentrated.

In the system 100 of the present disclosure, an evaporator configured to concentrate the acid solution and the alkaline solution by evaporating water through heating may be used for the concentration thereof.

Steam is supplied to each of the recovered chemicals so as to evaporate water contained therein, and the evaporated water is discharged as condensate. The chemicals concentrated to a target concentration of 20 to 50 wt % by evaporation are circulated to the precursor manufacturing process and reused.

In addition, the condensate discharged during the concentration by evaporation process is merged into a pipeline through which treated water from the water reclamation unit 170 is circulated to the chemical recovery unit 150 as a recovery solution, and is thereby recycled as the recovery solution of the chemical recovery unit 150.

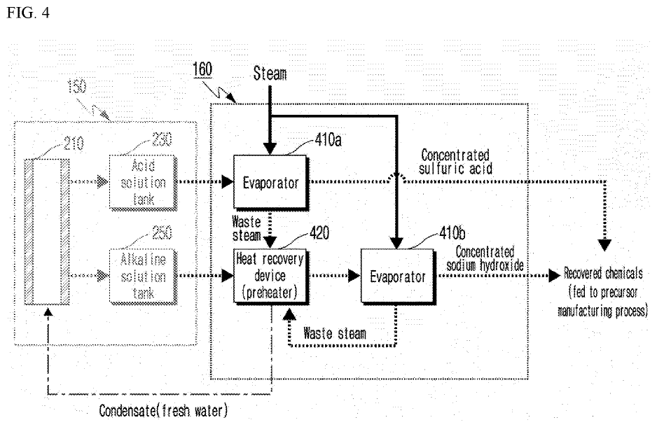

A detailed configuration of the chemical concentration unit 160 will be described below with reference to FIG. 4.

The water reclamation unit 170 receives the desalinated wastewater from the chemical recovery unit 150 and separates and concentrates residual pollutants from the wastewater. Treated water from which the pollutants have been removed in the water reclamation unit 170 is supplied as the recovery solution for the chemical recovery unit 150, and the residual pollutants separated and concentrated from the wastewater are discharged to the activated carbon adsorption unit 180.

The water reclamation unit 170 additionally removes residual pollutants from the wastewater having passed through the chemical recovery unit 150, thereby enabling the system 100 to achieve zero liquid discharge (ZLD) treatment.

The wastewater introduced into the water reclamation unit 170 via the chemical recovery unit 150 contains TDS in a range of 13,000 to 15,000 mg/L.

Accordingly, the water reclamation unit 170 may use a reverse osmosis (RO) membrane for additional removal of solids from the wastewater, but is not limited thereto as long as the process is capable of separating dissolved solids from the wastewater.

For example, when the water reclamation unit 170 is configured as an RO process, the RO process is operated at a recovery rate of 70 to 90%, and it is preferable to use a polyamide membrane having a salt rejection rate of 99.7%.

The water reclamation unit 170 configured as the RO process receives and filters the desalinated wastewater introduced from the chemical recovery unit 150. The treated water having passed through the RO process is discharged in a state in which most salts have been removed, with a TDS of less than 1,500 mg/L, and more preferably 1,000 mg/L or less, and the treated water is circulated to the chemical recovery unit 150 for use as the recovery solution (fresh water) of the chemical recovery unit 150.

TABLE 2

| Parameter | Concentration(mg/L) |
|---|---|
| COD | <0.1 |
| TDS | 700~1,000 |
| NH₄⁺ | <1.0 |
| Ni, Co, Mn | 0 |
| SS | 0 |
| Na⁺ | 300~500 |
| SO₄²⁻ | 700~900 |

Table 2 shows the water quality of the treated water discharged from the water reclamation unit 170 according to one embodiment of the present disclosure. As confirmed in Table 2, the treated water produced through the water reclamation unit 170 is in a state in which most organic matter, heavy metals, and ammonia components have been removed, and is therefore sufficient for recirculation and use as the recovery solution of the chemical recovery unit 150 or for reuse as other process water.

Meanwhile, RO concentrate that has not passed through the RO membrane contains TDS in a range of 50,000 to 70,000 mg/L, and such RO concentrate is discharged to the activated carbon adsorption unit 180 so that additional treatment is performed.

The activated carbon adsorption unit 180 receives the RO concentrate containing the residual pollutants separated and concentrated in the water reclamation unit 170, adsorptively removes organic matter from the RO concentrate, and then circulates it to the chemical recovery unit 150 for use as concentrate solution of the chemical recovery unit 150.

In the RO concentrate discharged from the water reclamation unit 170, residual salt components that have not been recovered by the chemical recovery unit 150 are still present. The system 100 of the present disclosure is capable of recovering all chemicals from the salt components contained in the wastewater generated during the manufacturing process of a cathode active material precursor. In this case, in order to maintain process efficiency within the chemical recovery unit 150, the RO concentrate from the water reclamation unit 170 is re-treated and supplied as concentrate solution to the chemical recovery unit 150.

In this case, since the RO concentrate discharged from the water reclamation unit 170 contains organic matter in a concentrated state in addition to the residual salt components, the activated carbon adsorption unit 180 is capable of adsorptively removing the organic matter from the concentrate.

The recirculated concentrate from which organic matter has been removed through the activated carbon adsorption unit 180 is reintroduced into the chemical recovery unit 150 for use as concentrate solution of the chemical recovery unit 150. In this case, the recirculated concentrate discharged from the activated carbon adsorption unit 180 is introduced into the concentrate solution supply line of the bipolar membrane electrodialysis apparatus of the chemical recovery unit 150, and is reintroduced at the concentrate solution supply flow path of a unit stack located in the downstream half of the plurality of unit stacks connected in series, specifically at or beyond the 50% point from the most upstream unit stack. As the wastewater introduced into the chemical recovery unit 150 undergoes a desalination process, the salt concentration in the solution gradually decreases, and, as a result, side reactions caused by overcurrent may occur at a downstream stage of the electrodialysis apparatus. Accordingly, in order to compensate therefor, it is preferable that the recirculated concentrate discharged from the activated carbon adsorption unit 180 be reintroduced at the concentrate solution supply flow path of a unit stack in the downstream half of the plurality of unit stacks of the electrodialysis apparatus.

The system 100 of the present disclosure circulates the entire volume of the final treated water discharged from the water reclamation unit 170 for reuse in the chemical recovery unit 150, and also recirculates condensate discharged from the chemical concentration unit 160 and recirculated concentrate discharged from the activated carbon adsorption unit 180 into the system 100 so as to be reused or re-treated. As a result, zero liquid discharge (ZLD) treatment of the wastewater generated during the manufacturing process of a cathode active material precursor can be achieved in the system 100 of the present disclosure.

FIGS. 2 and 3 are diagrams illustrating a specific configuration of the chemical recovery unit 150 according to one embodiment of the present disclosure.

FIG. 2 is a diagram illustrating a configuration of the bipolar membrane electrodialysis apparatus, which is the chemical recovery unit 150 of the present disclosure.

Referring to FIG. 2, the chemical recovery unit 150 of the present disclosure is configured as a bipolar membrane electrodialysis apparatus, and includes a unit stack 210, an acid solution tank 230, and an alkaline solution tank 250.

The bipolar membrane electrodialysis apparatus of the present disclosure comprises at least one unit stack 210, wherein the one or more unit stacks 210 are arranged in series and/or in parallel to receive wastewater from the membrane filtration unit 140 and sequentially recover acid solution and alkaline solution therefrom.

When a plurality of unit stacks 210 are provided and arranged in series, the chemical recovery unit 150 can ensure sufficient residence time within the chemical recovery unit 150 to recover most of the salt components contained in the wastewater generated during the manufacturing process of a cathode active material precursor. In addition, when a plurality of unit stacks 210 are provided in parallel, the chemical recovery unit 150 is capable of performing chemical recovery for a larger volume of wastewater.

For example, referring to FIG. 2, the chemical recovery unit 150 includes a plurality (n) of unit stacks 210 connected in series, such that recovery of acid solution and alkaline solution from wastewater, that is, a salt solution, can be performed over n stages.

The unit stack 210 receives wastewater (concentrate solution), performs desalination, and discharges the same after separation into acid solution, alkaline solution, and desalinated solution, respectively. One unit stack 210 includes a concentrate solution supply flow path, two recovery solution supply flow paths, an acid solution discharge flow path, an alkaline solution discharge flow path, and a desalinated solution discharge flow path.

The system 100 of the present disclosure includes at least one unit stack 210 as an electrodialysis apparatus, and the unit stack 210 may be configured in a form in which 100 to 200 unit cells are stacked. The number of unit stacks 210 included in the chemical recovery unit 150 and the number of unit cells stacked within each unit stack 210 may vary depending on the treatment capacity of the system 100 and the salt concentration of the influent wastewater. A detailed configuration of the unit stack 210 is illustrated in FIG. 3.

FIG. 3 is a diagram illustrating a unit stack structure of a bipolar membrane electrodialysis apparatus according to one embodiment of the present disclosure.

Referring to FIG. 3, the unit stack 210 includes an anode 311, an anion exchange membrane (AEM) 313, a cation exchange membrane (CEM) 315, a bipolar membrane (BPM) 317, a cathode 319, a concentrate solution inlet 330, a first recovery solution inlet 340, a second recovery solution inlet 350, an acid solution outlet 360, an alkaline solution outlet 370, and a desalinated solution outlet 380.

As described above, the unit stack 210 is formed by stacking a plurality of unit cells. Each unit cell includes a concentrate solution flow path, an acid solution flow path, and an alkaline solution flow path, and each flow path is separated by the cation exchange membrane, the bipolar membrane, and the anion exchange membrane. The unit stack 210 may be configured by repeatedly stacking a plurality of unit cells. Accordingly, the anion exchange membrane 313, the cation exchange membrane 315, and the bipolar membrane 317 are sequentially and repeatedly arranged between the anode 311 and the cathode 319 in the unit stack 210. In addition, spacers (not shown) are disposed between the ion exchange membranes and the bipolar membrane to form flow paths between the membranes.

The electrodialysis process is a process for separating ionic substances using, as a driving force, an electric field formed by ion exchange membranes and direct current (DC) power supplied across both ends thereof. When a salt (MX) is introduced, desalination is performed under a potential gradient as cations (M⁺) pass through the cation exchange membrane 315 and move toward the reduction electrode (cathode), and anions (X⁻) pass through the anion exchange membrane 313 and move toward the oxidation electrode (anode).

In addition, the bipolar membrane 317 has a structure in which an anion exchange layer and a cation exchange layer are combined, and, in a state in which the cation exchange layer of the bipolar membrane 317 is disposed to face the cathode 319 and the anion exchange layer thereof is disposed to face the anode 311, water molecules are dissociated into hydrogen ions (H⁺) and hydroxide ions (OH⁻).

The wastewater (concentrate solution) discharged from the membrane filtration unit 140 is supplied to the concentrate solution inlet 330 of the unit stack 210 and moves along a flow path formed between the anion exchange membrane 313 and the cation exchange membrane 315, and the desalinated solution produced within the unit stack 210 is discharged through the desalinated solution outlet 380.

Meanwhile, as described above, the bipolar membrane electrodialysis apparatus requires a recovery solution, that is, water, to be additionally introduced for desalination of the wastewater. In the present disclosure, treated water discharged from the water reclamation unit 170 is supplied as the recovery solution.

The recovery solution supplied to the unit stack 210 is introduced through the first recovery solution inlet 340 and the second recovery solution inlet 350. The supplied recovery solution moves along flow paths formed between the bipolar membrane 317 and the anion exchange membrane 313, between the bipolar membrane 317 and the cation exchange membrane 315, between the anode 311 and the ion exchange membrane, and between the cathode 319 and the ion exchange membrane, thereby recovering acid solution and alkaline solution. The acid solution recovered in the unit stack 210 is discharged through the acid solution outlet 360, and the alkaline solution is discharged through the alkaline solution outlet 370.

Referring again to FIG. 2, when the chemical recovery unit 150 includes a plurality (n) of unit stacks 210 arranged in series, an acid solution discharge flow path of the (n−2)-th unit stack 210(n−2) is connected to one of the recovery solution supply flow paths of the (n−1)-th unit stack 210(n−1), and an alkaline solution discharge flow path of the (n−2)-th unit stack 210(n−2) is connected to the other recovery solution supply flow path of the (n−1)-th unit stack 210(n−1). In addition, a desalinated solution discharge flow path of the (n−2)-th unit stack 210(n−2) is connected to the concentrate solution (wastewater) supply flow path of the (n−1)-th unit stack 210(n−1).

In this case, fresh water supplied from the water reclamation unit 170 is introduced into the chemical recovery unit 150 through the two recovery solution supply flow paths of the first unit stack 210(1). Thereafter, while passing through the plurality of unit stacks 210, acid solution and alkaline solution are respectively recovered and move along the recovery solution supply flow paths. As a result, the acid solution and the alkaline solution discharged through the acid solution discharge flow path and the alkaline solution discharge flow path of the n-th unit stack 210(n) are finally discharged to and collected in the acid solution tank 230 and the alkaline solution tank 250, respectively.

In summary, fresh water (recovery solution) and wastewater (concentrate solution) are supplied to the most upstream unit stack 210 among the plurality of unit stacks 210 of the chemical recovery unit 150, and, when a voltage is applied to the electrodialysis apparatus, recovery of sulfuric acid (H₂SO₄) and sodium hydroxide (NaOH) from the supplied wastewater is initiated. Through this process, the sulfuric acid discharged from the most downstream unit stack 210 among the plurality of unit stacks 210 is collected in the acid solution tank 230, and the sodium hydroxide is collected in the alkaline solution tank 250, respectively.

In addition, the desalinated solution discharged from the first unit stack 210(1) is introduced as a concentrate solution into the second unit stack 210(2), in which desalination is performed again. As a result, in the n-th unit stack 210(n), a desalination process is performed in which acid solution and alkaline solution are recovered over n stages from the wastewater introduced from the membrane filtration unit 140.

Meanwhile, the ion transport occurring in the electrodialysis process may be understood as a result obtained by applying ion concentration polarization (ICP) occurring at the ion exchange membrane to a convection-diffusion equation. In this case, the concentration profile near the ion exchange membrane is linearly formed by a balance between ion transport by electrophoresis and ion transport by diffusion, and the concentration gradient increases as a higher voltage is applied.

The concentration gradient, or ion transport (current) resulting therefrom, cannot increase indefinitely and reaches a maximum when the concentration at the interface between the ion exchange membrane and the solution becomes zero, which is referred to as a limiting current value due to the diffusion limit. Since the largest amount of salt ions can be removed at the voltage at which such a limiting current appears, the limiting current value is generally set as an optimum process value in a desalination system based on an electrodialysis method.

Since the limiting current varies depending on the type and concentration of the solution, the electrodialysis apparatus may be operated within a range not exceeding the limiting current determined experimentally, thereby maximizing the effect of the system.

The chemical recovery unit 150 of the present disclosure operates the electrodialysis apparatus in a constant-current mode, that is, in a mode in which a constant current is supplied regardless of changes in the concentration of the solution inside the unit stack 210, thereby facilitating control of the overall electrodialysis reaction.

However, the chemical recovery unit 150 of the present disclosure includes a plurality of unit stacks 210 of the electrodialysis apparatus arranged in series to desalinate wastewater. In this case, as the wastewater passes through the plurality of unit stacks 210, desalination continuously proceeds, and, when the wastewater reaches a unit stack 210 at a certain stage, the ion concentration in the wastewater decreases, resulting in a phenomenon in which the current is rapidly reduced.

As described above, when the concentration of the concentrate solution introduced into the unit stack 210 decreases such that the operating current exceeds the limiting current, side reactions such as hydrolysis, salt precipitation, and membrane fouling may occur. In the present disclosure, the desalinated water discharged from the chemical recovery unit 150 is discharged as concentrate through the water reclamation unit 170, and the concentrate passes through the activated carbon adsorption unit 180 so that organic matter is removed therefrom. The recirculated concentrate from which the organic matter has been removed is reintroduced into the chemical recovery unit 150, thereby effectively preventing an overcurrent phenomenon.

Referring to FIG. 2, the recirculated concentrate discharged from the activated carbon adsorption unit 180 is merged into the concentrate solution (wastewater) supply flow paths of the plurality of unit stacks 210. In this case, it is preferable that the point at which the recirculated concentrate is merged is the concentrate solution (wastewater) supply flow path after a unit stack 210 located beyond 50% of the n unit stacks 210 from the most upstream side, that is, after the (n/2)-th unit stack 210(n/2).

The feed rate at which the recirculated concentrate discharged from the activated carbon adsorption unit 180 is reintroduced into the chemical recovery unit 150 is set such that the recirculated concentrate is supplied within a range in which the salt concentration of the recirculated concentrate does not exceed the initial salt concentration, that is, the salt concentration of the wastewater introduced from the membrane filtration unit 140.

The acid solution tank 230 and the alkaline solution tank 250 temporarily store the sulfuric acid and sodium hydroxide recovered from the unit stack 210 of the bipolar membrane electrodialysis apparatus until the same are supplied to the chemical concentration unit 160.

The chemical recovery unit 150 of the present disclosure is capable of recovering only acid solution and alkaline solution without generating other by-products by applying the bipolar membrane electrodialysis apparatus, thereby enabling treatment in a low-pollution and pollution-free manner.

Meanwhile, the chemical recovery unit 150 of the present disclosure may drive the bipolar membrane electrodialysis apparatus by receiving electric power produced from a renewable-energy-based power generation system. For example, the bipolar membrane electrodialysis apparatus of the present disclosure may be driven by receiving all or part of the power applied to the anode 311 and the cathode 319 provided in each unit stack 210 from a power generation system that produces electric power using renewable energy, such as solar power or wind power.

FIG. 4 is a diagram illustrating a configuration of the chemical concentration unit 160 according to one embodiment of the present disclosure.

The chemical concentration unit 160 concentrates the recovered acid solution and alkaline solution by evaporation to concentrations required in the precursor manufacturing process.

Referring to FIG. 4, the chemical concentration unit 160 includes evaporators 410 and a heat recovery device 420.

The evaporators 410a and 410b respectively receive the acid solution and the alkaline solution recovered from the chemical recovery unit 150 and steam from an external source, and concentrate the chemicals by raising the temperature to a range of 120 to 150° C. to evaporate water. The concentrated chemicals are introduced into the manufacturing process for reuse in the precursor manufacturing process, and waste steam discharged during the evaporation process is reused in the process by recovering energy therefrom. In addition, water from which energy has been recovered is discharged as condensate, which may be circulated for use as the recovery solution of the chemical recovery unit 150.

In this case, one of the evaporators 410b for the acid solution or the alkaline solution may further include a heat recovery device 420 at an upstream stage, and may receive waste steam discharged from the other evaporator 410a that concentrates the other chemical, thereby preheating the chemical undergoing concentration in the one evaporator 410b.

For example, the heat recovery device 420 is disposed at an upstream stage of the evaporator 410b for the alkaline solution. The heat recovery device 420 receives the alkaline solution from the alkaline solution tank 250, and preheats the alkaline solution by receiving waste steam discharged from the evaporator 410a for the acid solution and waste steam discharged from the evaporator 410b for the alkaline solution.

As described above, by recycling the waste steam generated in the evaporator 410 for the acid solution or the alkaline solution to preheat the other chemical, up to 30 to 50% of the steam consumed in the chemical concentration unit 160 can be saved. As means for recycling steam, a mechanical vapor recompressor (MVR, not shown), a thermal vapor recompressor (TVR, not shown), or the like may be applied.

In the process of treating wastewater generated during the manufacturing process of a cathode active material precursor, the system 100 of the present disclosure arranges a series of unit processes as pretreatment to effectively recover chemicals, thereby providing advantages in that resources can be recycled, environmental damage caused by waste discharged into the ecosystem can be reduced, and precursor production costs can be decreased.

In addition, the final treated water discharged within the system 100 and the concentrate discharged from the unit processes is recirculated as concentrate solution of the chemical recovery unit 150 so that the operation of the chemical recovery unit 150 can be stably maintained, while simultaneously recovering the entire amount of chemicals contained in the wastewater, thereby providing an advantage in that the wastewater generated during the precursor manufacturing process can be treated with complete zero liquid discharge (ZLD).

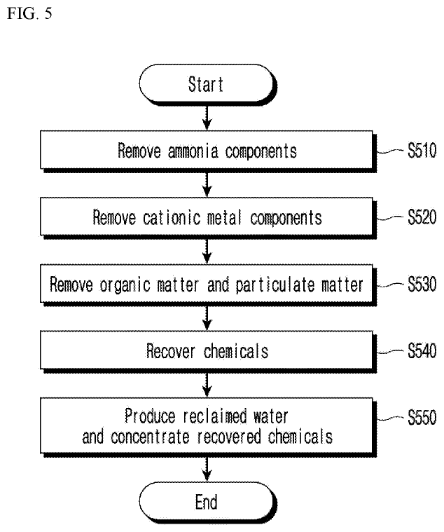

FIG. 5 is a flowchart illustrating a method for zero liquid discharge (ZLD) treatment of wastewater generated during the manufacturing process of a cathode active material precursor for a secondary battery according to one embodiment of the present disclosure.

First, an ammonia component is removed from the wastewater generated during the cathode active material precursor manufacturing process (S510).

The wastewater generated during the cathode active material precursor manufacturing process contains high-concentration ammonium ions (NH₄⁺), and the ammonia component is removed from the wastewater by stripping the introduced wastewater with air. In this case, the ammonia component removed from the wastewater is recovered in the form of aqueous ammonia and is introduced for recycling in the precursor manufacturing process.

Next, cationic metal components are removed from the wastewater from which the ammonia component has been removed (S520).

As the wastewater from which the ammonia component has been removed passes through an ion exchange resin, metal ion components in the wastewater are removed. The wastewater generated during the precursor manufacturing process contains a plurality of metal ions, and these metal ions are removed from the wastewater using a cation exchange resin. The metal components removed by the ion exchange resin may be recovered depending on the concentration thereof and recycled as raw materials for the precursor manufacturing process.

Subsequently, organic matter and particulate matter are removed from the wastewater from which the ammonia component and the metal ions have been removed (S530).

In order to remove the organic matter and particulate matter from the wastewater, membrane filtration unit 140 may be applied, and, in particular, ultrafiltration (UF) may be applied. The wastewater from which the organic matter and particulate matter have been removed through the membrane filtration is discharged to the chemical recovery unit 150.

Chemicals are recovered from the wastewater from which organic matter and particulate matter have been removed (S540).

The chemical recovery unit 150 receives the wastewater from which ammonia components, metal ions, organic matter, and particulate matter have been removed through the series of preceding pretreatment processes, and recovers acid solution and alkaline solution from the high-salinity wastewater using the bipolar membrane electrodialysis (BMED) apparatus. In this case, the introduced wastewater may undergo multistage desalination treatment while passing through the BMED apparatus in which a plurality of unit stacks 210 are arranged in series.

The recovered chemicals are discharged to the chemical concentration unit 160 to be introduced into the precursor manufacturing process for recycling, and the desalinated wastewater is discharged to the water reclamation unit 170.

Reclaimed water is produced by treating the desalinated wastewater, and the recovered chemicals are concentrated (S550).

The water reclamation unit 170 removes salts and organic matter remaining in the desalinated wastewater using a reverse osmosis (RO) membrane process, and the treated water having passed through the RO membrane is supplied to the chemical recovery unit 150 for use as a recovery solution for the BMED apparatus. The RO concentrate that has not been filtered in the water reclamation unit 170 is discharged as recirculated concentrate after additional removal of organic matter in the activated carbon adsorption unit 180, and is reintroduced into the concentrate solution supply flow path to replenish the salt concentration in the chemical recovery unit 150.

In addition, the chemicals recovered in the chemical recovery step are concentrated by supplying steam to evaporate water, so that the concentrations thereof are adjusted to levels suitable for use in the precursor manufacturing process, and are then reintroduced into the precursor manufacturing process.

Although the processes are described as being performed sequentially in FIG. 5, this is only an example of explaining the technical idea of one embodiment of the present disclosure. In other words, since those skilled in the art to which one embodiment of the present disclosure pertains may change and execute the order of the processes described in the respective diagrams without departing from the essential characteristics of one embodiment of the present disclosure, or can be applied by modifying and transforming the processes in various ways by executing one or more processes among the processes in parallel, FIG. 5 is not limited to a chronological order.

The above description is merely an illustrative explanation of the technical idea of this embodiment, and those skilled in the art to which this embodiment pertains will be able to make various modifications and variations without departing from the essential characteristics of this embodiment. Accordingly, these embodiments are not intended to limit the technical idea of this embodiment, but rather to explain it, and the scope of the technical idea of this embodiment is not limited by such an embodiment. The scope of protection of this embodiment should be interpreted in accordance with the claims below, and all technical ideas within the scope equivalent thereto should be interpreted as being included in the scope of rights of this embodiment.

What is claimed is:

1. A system for zero liquid discharge (ZLD) treatment of wastewater generated during a manufacturing process for a cathode active material precursor of a secondary battery, the wastewater containing heavy metals and a high concentration of ammonia, the system comprising:
an ammonia stripping unit configured to strip an ammonia component from the wastewater generated during the manufacturing process for the precursor;
an ion exchange (IX) unit configured to receive the wastewater from which the ammonia component has been removed and remove metal ions from the wastewater;
a chemical recovery unit configured to recover an acid solution and an alkaline solution from the wastewater from which the ammonia component and the metal ions have been removed; and
a water reclamation unit configured to filter the wastewater from which the acid solution and the alkaline solution have been recovered and produce reclaimed water for use in the system.

2. The system of claim 1, further comprising a chemical concentration unit configured to concentrate the acid solution and the alkaline solution recovered by the chemical recovery unit and resupply the concentrated acid solution and the concentrated alkaline solution to the precursor manufacturing process.

3. The system of claim 1, further comprising a membrane filtration unit configured to receive the wastewater treated by the ion exchange unit, remove organic matter and particulate matter therefrom, and discharge the treated wastewater to the chemical recovery unit.

4. The system of claim 1, wherein the chemical recovery unit comprises a bipolar membrane electrodialysis (BMED) apparatus configured to receive the wastewater and recover the acid solution and the alkaline solution therefrom.

5. The system of claim 4, wherein the bipolar membrane electrodialysis apparatus comprises a plurality of unit stacks arranged in series and configured to receive the wastewater and recover the acid solution and the alkaline solution in multiple stages while desalinating the wastewater.

6. The system of claim 5, wherein each of the plurality of unit stacks comprises:
an anode;
a cathode; and
a plurality of anion exchange membranes (AEMs), cation exchange membranes (CEMs), and bipolar membranes (BPMs) disposed between the anode and the cathode, wherein the plurality of membranes are repeatedly arranged in an order of an anion exchange membrane, a cation exchange membrane, and a bipolar membrane, and wherein spacers are disposed between adjacent ones of the plurality of membranes.

7. The system of claim 5, wherein the bipolar membrane electrodialysis apparatus is configured to receive, as a recovery solution for recovering the acid solution and the alkaline solution from the wastewater, final treated water produced by the water reclamation unit.

8. The system of claim 5, wherein the bipolar membrane electrodialysis apparatus is configured to receive electric power from a solar power generation system or a wind power generation system as a power source applied to an anode and a cathode.

9. The system of claim 1, wherein the wastewater generated during the precursor manufacturing process and introduced into the ammonia stripping unit has a pH of 10 or greater.

10. The system of claim 5, further comprising an activated carbon adsorption unit configured to receive concentrate in which residual pollutants not filtered by the water reclamation unit are concentrated, and remove organic matter from the concentrate, wherein the concentrate from which the organic matter has been removed is recirculated to the chemical recovery unit and merged into a flow path for supplying the concentrate solution to the plurality of unit stacks.

11. The system of claim 1, wherein the ion exchange unit comprises a cation exchange resin, and wherein the wastewater introduced into the ion exchange unit contains at least one metal ion selected from the group consisting of nickel (Ni), cobalt (Co), manganese (Mn), and aluminum (Al).

12. The system of claim 1, wherein the water reclamation unit is a reverse osmosis (RO) membrane apparatus.

13. A method for zero liquid discharge (ZLD) treatment of wastewater generated during a manufacturing process for a cathode active material precursor of a secondary battery, the wastewater containing heavy metals and a high concentration of ammonia, the method comprising:
removing an ammonia component from the wastewater generated during the precursor manufacturing process;
removing metal ions from the wastewater from which the ammonia component has been removed;
removing organic matter and particulate matter from the wastewater from which the metal ions have been removed;
recovering sulfuric acid (H₂SO₄) and sodium hydroxide (NaOH) from the wastewater from which the organic matter and the particulate matter have been removed; and
additionally removing residual salts from the wastewater from which the sulfuric acid and the sodium hydroxide have been recovered and which has been desalinated, to produce reclaimed water.

14. The method of claim 13, wherein the produced reclaimed water is reused by being supplied to the step of recovering the sulfuric acid and the sodium hydroxide.

15. The method of claim 13, wherein the removing of the ammonia component comprises stripping the wastewater with air or steam to remove ammonia from the wastewater.

16. The method of claim 13, wherein the recovering of the sulfuric acid and the sodium hydroxide comprises recovering the sulfuric acid and the sodium hydroxide from the wastewater using a bipolar membrane electrodialysis (BMED) apparatus.
